(19) United States
(12) Patent Application Publication
(10) Pub. No.: US 2004/0101126 A1
(43) Pub. Date: May 27, 2004

(54) Method of and apparatus for processing information, and computer product

(75) Inventor: Naoko Ohmori, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/715,386

(22) Filed: Nov. 19, 2003

(30) Foreign Application Priority Data
Nov. 22, 2002 (JP) 2002-340176

(51) Int. Cl. H04M 5/00; H04M 3/00; H04M 15/06; H04M 1/56

(52) U.S. Cl. 379/265.01; 379/142.01

(57) ABSTRACT

When an incoming telephone call for a certain staff is answered by another staff, a display indicating who is the caller, to whom the caller wants to speak, and how to respond to the call, is displayed on a display of a PC near the another staff. The response method is indicated by a background color on the screen, and for example, yellow indicates that a message is to be delivered to the caller, blue indicates that the telephone call is to be transferred to the staff in charge, and red indicates that the call is to be rejected gently. When a report is required, for example in the case of message, it is notified to the staff in charge by an electronic mail, immediately after the telephone conversation, whether the message is delivered to the caller, and the like.

### CROSS-REFERENCE TO RELATED APPLICATIONS

This application is based upon and claims the benefit of priority from the Japanese Patent Application No. 2002-340176, filed on Nov. 22, 2002, the entire contents of which are incorporated herein by reference.

### BACKGROUND OF THE INVENTION

1) Field of the Invention

The present invention relates to an information processing method, an information processing program, and an information processing apparatus, which displays information of a caller and an instruction how to respond the call.

2) Description of the Related Art

It is common even in a large company, in which every staff has a telephone on his/her desk, that only one outside line is provided for each group, such as a department or a section, so that every staff in the group can answer incoming calls from with the telephone on their desk.

Japanese Patent Application No. H1-234283 (not yet Laid-open) discloses to display caller's name after identifying the caller from the incoming telephone number.

However, if staff in charge is out of office, another staff who has answered the phone may not respond appropriately due to unfamiliarity with the caller. For example, he/she may respond to an important customer carelessly, or may respond to a call for sales purpose unnecessarily politely, and taking time more than it necessary is.

Further, even if the staff in charge has given instructions how to respond, to other staff, when the other staff actually answers the phone, he/she may forget about it or does not remember the instructions exactly, and a message for the caller may be ambiguous.

According to Japanese Patent Application Laid-open Publication No. H1-234283, personal information is displayed by identifying the caller from the incoming telephone number, but since the display shows only the caller's telephone number, staff other than the one in charge cannot have enough information, and can only guess how to respond to the call from the caller's name.

Further, the caller has to explain about his/her section, telephone number, and the situation and background why he/she is calling, which will not be necessary if the staff in charge is in the office, in order to leave a message.

Even after the telephone conversation is over, delivery of the message from the actually responded staff to the staff in charge may be incomplete or delayed. In the related art, when the staff in charge cannot answer the telephone, smooth and appropriate response is not possible, thereby degrading business efficiency.

### SUMMARY OF THE INVENTION

It is an object of the present invention to solve at least the problems in the conventional technology.

A method for processing information according to one aspect of the present invention includes extracting information relating to a telephone caller; deciding a background color of a window based on a response method specified by a staff in charge, as a target for responding to the caller, corresponding to the caller; and displaying the information relating to the caller in a window with the background color decided.

An apparatus for processing information according to another aspect of the present invention includes a caller information extracting unit that extracts information relating to a telephone caller; a background color deciding unit that decides a background color of a window based on a response method specified by a staff in charge, as a target for responding to the caller, corresponding to the caller; and a display unit that displays the information relating to the caller in a window with the background color decided.

The computer program according to still another aspect of the present invention realizes the method according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a diagram illustrating one example of a response method specifying screen, in an information processing apparatus according to the embodiment of the present invention;

FIG. 2 is a diagram illustrating one example of an information display screen, in the information processing apparatus according to the embodiment of the present invention;

FIG. 3 is a diagram illustrating one example of a response result input screen, in the information processing apparatus according to the embodiment of the present invention;

FIG. 4 is a diagram illustrating one example of an electronic mail transmitted to staff in charge who is out of office, by the information processing apparatus according to the embodiment of the present invention;

FIG. 5 is a diagram illustrating one example of a business inquiry screen, in the information processing apparatus according to the embodiment of the present invention;

FIG. 6 is a diagram illustrating another example of a response result input screen, in the information processing apparatus according to the embodiment of the present invention;

FIG. 7 is a diagram illustrating another example of an electronic mail transmitted to staff in charge who is out of office, by the information processing apparatus according to the embodiment of the present invention;

FIG. 8 is block diagram indicating one example of a hardware configuration of the information processing apparatus according to the embodiment of the present invention;

FIG. 9 is a diagram illustrating a functional configuration of the information processing apparatus according to the embodiment of the present invention;

FIG. 10 is a diagram schematically illustrating the contents of a customer master 902 according to the embodiment of the present invention,

FIG. 11 is a diagram schematically illustrating the contents of an employee master 904 according to the embodiment of the present invention;

FIG. 12 is a diagram schematically illustrating the contents of a schedule master 906 according to the embodiment of the present invention;

FIG. 13 is a diagram schematically illustrating the contents of a meeting history master 908 according to the embodiment of the present invention;

FIG. 14 is a diagram schematically illustrating the contents of a response method master 910 according to the embodiment of the present invention;

FIG. 15 is a diagram schematically illustrating the contents of a background color master 912 according to the embodiment of the present invention;

FIG. 16 is a flowchart indicating a procedure in response method display processing, in the information processing apparatus according to the embodiment of the present invention;

FIG. 17 is a flowchart indicating a procedure in caller information extracting processing, in the information processing apparatus according to the embodiment of the present invention;

FIG. 18 is a flowchart indicating a procedure in staff information extracting processing, in the information processing apparatus according to the embodiment of the present invention;

FIG. 19 is a flowchart indicating a procedure in meeting schedule extracting processing, in the information processing apparatus according to the embodiment of the present invention; and

FIG. 20 is a flowchart indicating a procedure in response result notifying processing, in the information processing apparatus according to the embodiment of the present invention.

### DETAILED DESCRIPTION

Exemplary embodiments of the information processing method, the information processing program, and the information processing apparatus will be explained below in detail, with reference to the accompanying drawings.

According to the present invention, when an incoming telephone call for staff A, who is out of office at the time, is to be answered by another staff B by his/her telephone, a display indicating who is the caller, to whom the caller wants to speak, and how to respond, is displayed on a display of a personal computer (hereinafter, “PC”) near the telephone. The PC is a PC used by the staff B.

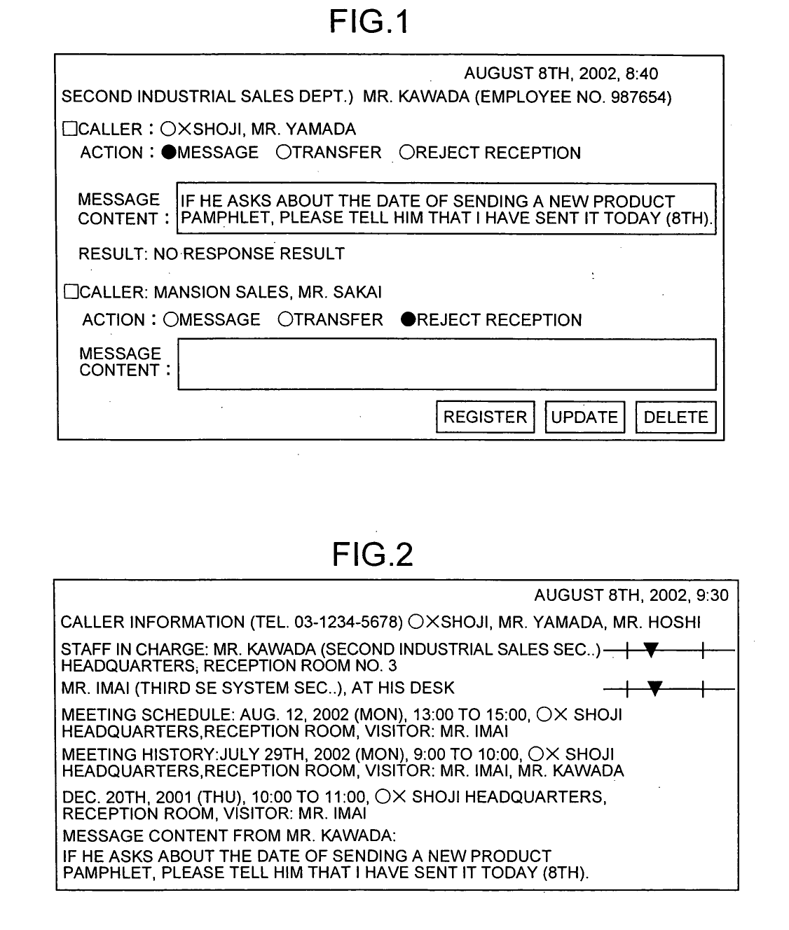

The staff A registers in advance the response method for calls while he/she is away, for each of callers, on a screen as shown in FIG. 1. There are following four modes in the response methods that can be specified.

(1) Message, Background color: Yellow

This mode is set when there is some message for the caller. This message may be delivered to the caller, even if the caller does not ask.

FIG. 2 illustrates one example of a screen displayed on the PC of the staff B who has answered the phone, when the staff A specifies a “message” as the response method. On the screen, following items are described, and yellow is set as the background color:

(a) Information of a customer, who the caller is (hereinafter, “caller information”);

(b) Information of staff in charge in the company, who should originally respond to the customer (hereinafter, “staff information”);

(c) Meeting schedule of the staff in charge with the customer (hereinafter, “meeting schedule”);

(d) Meeting history of the staff in charge with the customer (hereinafter, “meeting history”); and

(e) Message content to be delivered to the customer (hereinafter, “message content”).

(2) Transfer, Background color: Blue

Even if the staff in charge is away, the staff is in a location where he/she can be told of the phone call (in other staff's location, or in a meeting room in the same premises), the phone call can be transferred to the telephone in such a location. When the staff A specifies “transfer”, the same screen as that shown in FIG. 2 is displayed on the PC of the staff B, but it is different in that the displayed information is only from (a) to (d), and that the background color is not yellow but blue.

(3) Reject reception, Background color: Red

This mode asks the other staff to reject the call, by telling the caller amicably, such as “He/she is taking a day off”. This mode is set when the caller is a persistent salesman, or the staff A does not want to speak to this caller, due to unsettled issue or the like. When the staff A specifies “reject reception”, the same screen as that shown in FIG. 2 is displayed on the PC of the staff B, but it is different in that the displayed information is only from (a) to (d), and that the background color is not yellow but red.

(4) No specification, Background color: Green or White

When the staff A does not particularly specify the response method, it is assumed that “no specification” is specified. In the case of “no specification”, how to respond to the call is entrusted to the staff B who has actually answered the phone. In this case, the same screen as that shown in FIG. 2 is displayed on the PC of the staff B, but it is different in that the displayed information is only from (a) to (d), and that the background color is not yellow but green (when there is a meeting schedule in the near future) or white (when there is no meeting schedule).

The staff B responds to the phone as instructed by the staff A, referring to the screen. In the case of (2) “transfer” or (3) “reject reception”, there is nothing to do any further. However, in the case of (1) “message”, or (4) there is no specification, but the caller leaves a message, the staff B must report the reaction of the caller or the message to the staff A.

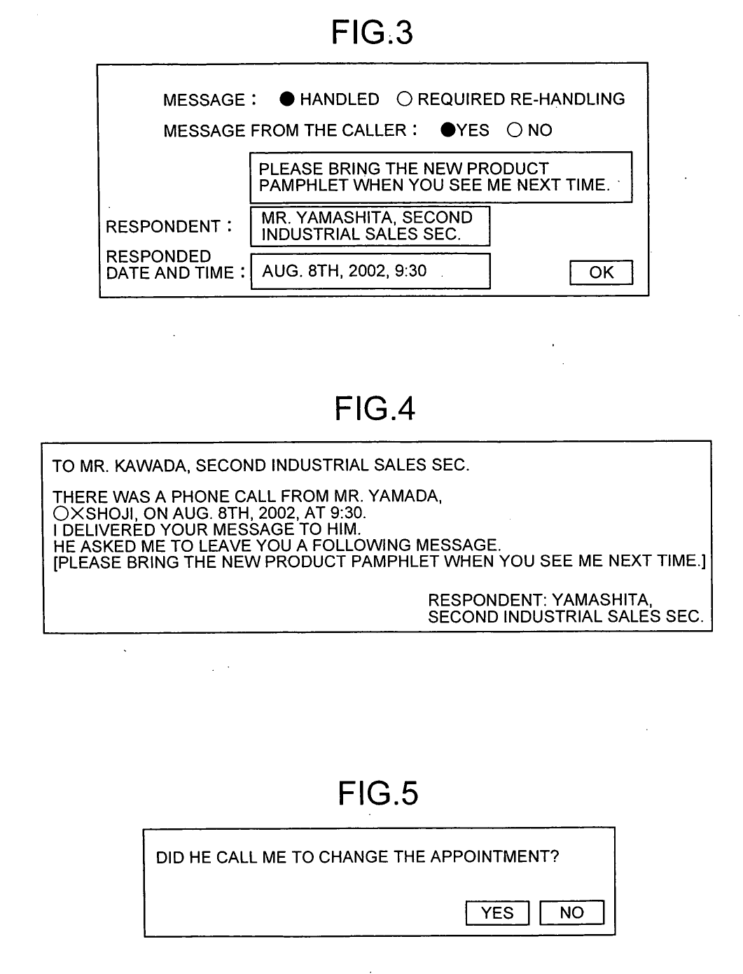

In the case of (1) “message”, a screen as shown in FIG. 3 is displayed after finishing the call. Therefore, the staff B inputs whether he/she has passed on the message from the staff A to the caller, or the message left by the caller to the staff A, and his/her name and date and time of reception (in the figure, the user of the PC is displayed in a “respondent” column, and the current date and time are displayed in a “responded date and time” column, respectively by default, and these should be changed according to need). The contents input here are transmitted to the staff A in an electronic mail as shown in FIG. 4.

In the case of (4) “no specification”, the staff B responds in various ways, but when the caller having an appointment with the staff A in the near future asks if it is possible to change the date and time or location for the appointment, it is necessary to report this situation quickly and reliably to the staff A.

In the present invention, therefore, even if the staff A does not specify the response method, when there is a phone call from a customer who has an appointment with the staff A in the future, after finishing the call, the staff A asks the staff B if the customer wants to change the appointment, by a screen as shown in FIG. 5.

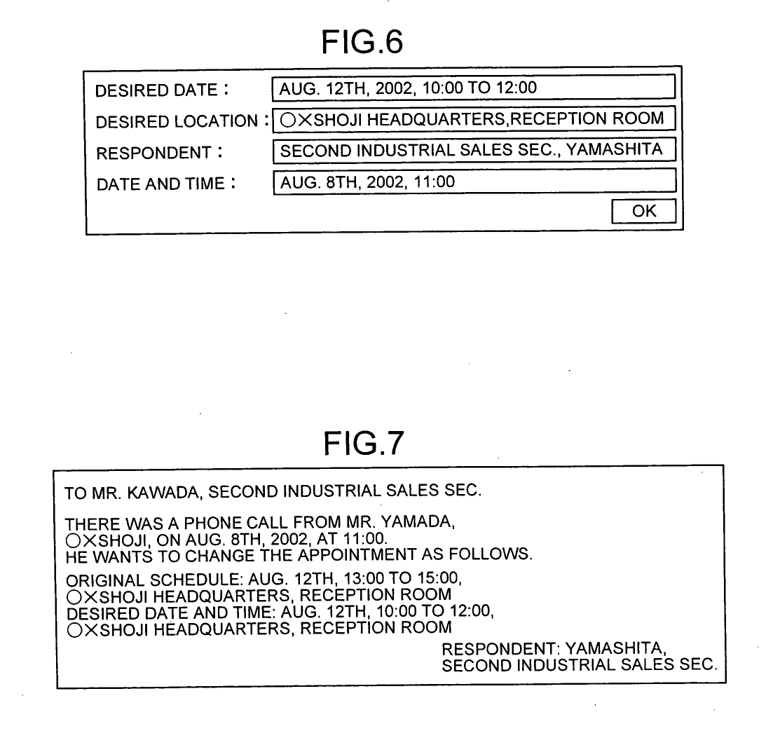

When the customer wants to change the appointment, the staff B is to input the changed date and time or location, the respondent and the responded date and time on a screen as shown in FIG. 6 (in the figure, the user of the PC is displayed in a “respondent” column, and the current date and time are displayed in a “responded date and time” column, respectively by default, and these should be changed according to need). The contents input here are transmitted to the staff A in an electronic mail as shown in FIG. 7.

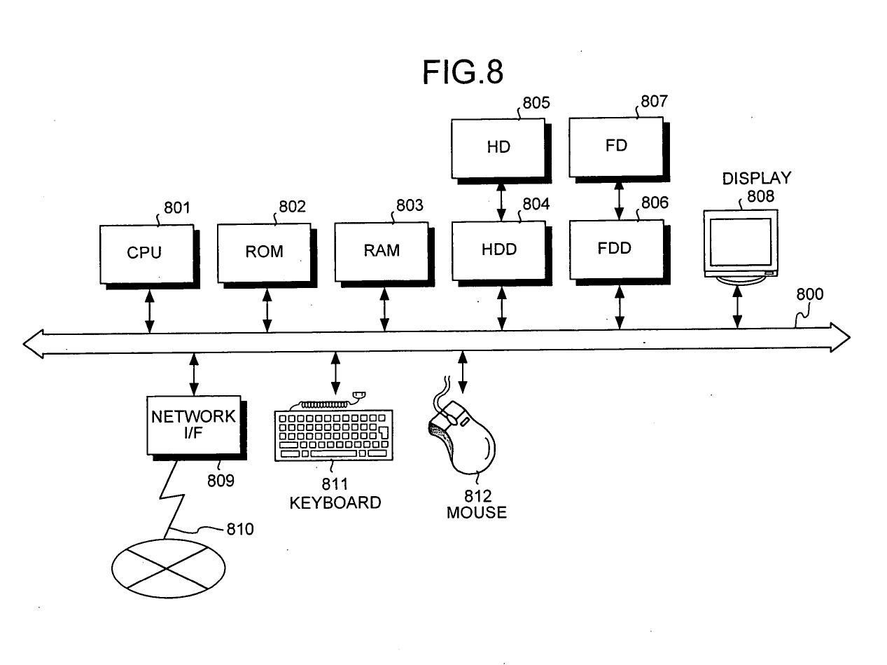

FIG. 8 is block diagram indicating one example of a hardware configuration of the information processing apparatus according to the embodiment of the present invention.

The information processing apparatus according to the embodiment includes a central processing unit (hereinafter, “CPU”) 801, a read only memory (hereinafter, “ROM”) 802, a random access memory (hereinafter, “RAM”) 803, a hard disk drive (hereinafter, “HDD”) 804, a hard disk (hereinafter, “HD”) 805, a flexible disk drive (hereinafter, “FDD”) 806, a flexible disk (hereinafter, “FD”) 807 as one example of a detachable recording medium, a display 808, a network interface (hereinafter, “I/F”) 809, a keyboard 811, and a mouse 812. The respective sections are connected via a bus or a cable 800.

The CPU 801 controls the whole apparatus. The ROM 802 stores programs such as a boot program. The RAM 803 is used as a work area for the CPU 801.

The HDD 804 controls read and write of data with respect to the HD 805, under control of the CPU 801. The HD 805 stores the written data under control of the HDD 804.

The FDD 806 controls read and write of data with respect to the FD 807, under control of the CPU 801. The FD 807 stores the written data under control of the FDD 806. The detachable recording medium may be a CD-ROM (CD-R, CD-RW), a magnet optical (hereinafter, “MO”), a digital versatile disk (hereinafter, “DVD”), or a memory card, other than the FD 807.

The display 808 is for example a cathode ray tube (CRT), a thin film transistor (TFT) liquid crystal display, or a plasma display, and displays a cursor, windows, icons, and various data such as document and images. The network I/F 809 is connected to the local area network (hereinafter, “LAN”) through the network cable 810, for transferring data between the LAN and the apparatus.

The keyboard 811 includes keys for inputting characters, figures, and various instructions, to input data in the apparatus. The keyboard 811 may be a touch panel type input pad, or ten keys. The mouse 812 is for moving a cursor or selecting the range, or moving a window or changing the size of the window. A track ball, a joystick, a cross key, or a jog dial may be used, so long as it has the similar function as a pointing device.

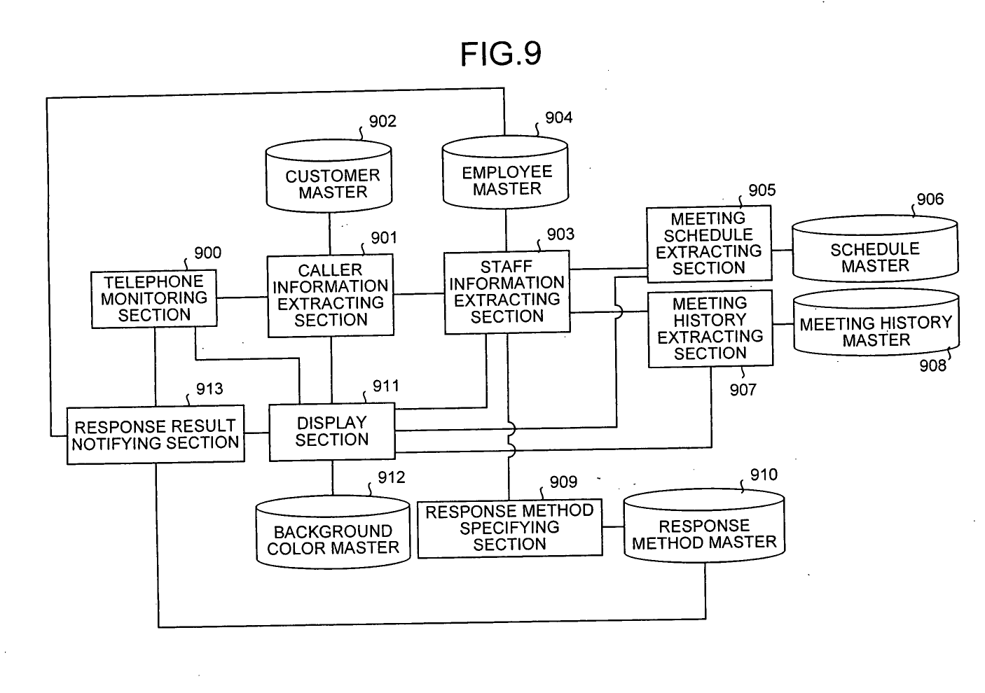

FIG. 9 is a diagram illustrating a functional configuration of the information processing apparatus according to the embodiment of the present invention.

The information processing apparatus according to the embodiment includes a telephone monitoring section 900, a caller information extracting section 901, a customer master 902, a staff information extracting section 903, an employee master 904, a meeting schedule extracting section 905, a schedule master 906, a meeting history extracting section 907, a meeting history master 908, a response method specifying section 909, a response method master 910, a display section 911, a background color master 912, and a response result notifying section 913. The details of functions of the respective sections will be explained later with reference to the flowchart, and only the outline thereof is described here.

The telephone monitoring section 900 is a functional section that detects an incoming telephone call to a telephone installed near this apparatus (normally, the same staff uses the apparatus and the telephone), and pickup or hang-up of the receiver. When there is an incoming telephone call, the telephone monitoring section 900 identifies the telephone number of the caller, and outputs the telephone number to the caller information extracting section 901, and when the receiver is picked up or hung up, that is, when telephone conversation has started or finished, informs this matter to the display section 911 described later.

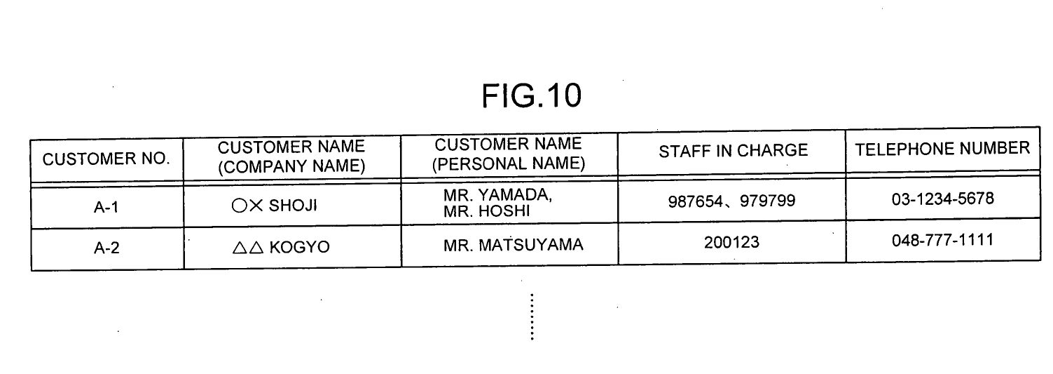

The caller information extracting section 901 is a functional section that refers to the customer master 902 as shown in FIG. 10, by the telephone number input from the telephone monitoring section 900, to extract a record of a customer specified by this number. The caller information extracting section 901 then outputs the whole items of the extracted record to the display section 911, and outputs the customer number (identification number of the customer) and the telephone number input from the telephone monitoring section 900 to the staff information extracting section 903 described later.

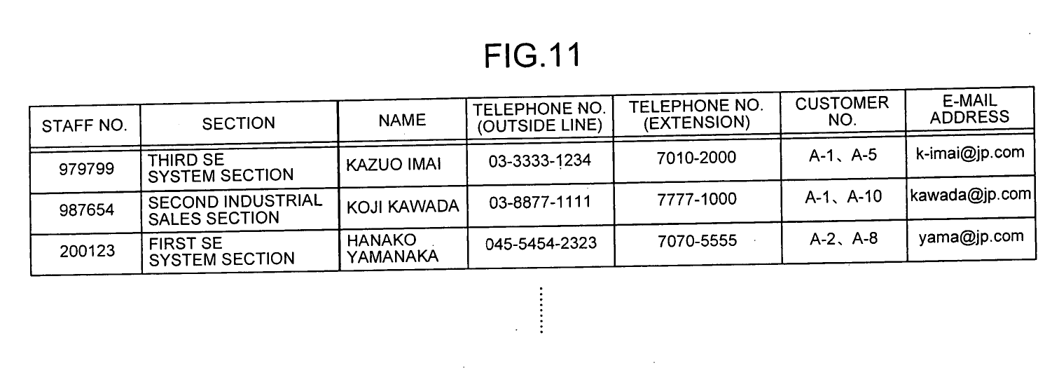

Returning to FIG. 9, the staff information extracting section 903 is a functional section that refers to the employee master 904 as shown in FIG. 11 by the customer number input from the caller information extracting section 901, to extract a record of staff who is in charge of the customer specified by the number. The staff information extracting section 903 then outputs the whole items of the extracted record to the display section 911, and outputs an employee number (identification number of the staff), and the customer number and the telephone number input from the caller information extracting section 901 to the meeting schedule extracting section 905, the meeting history extracting section 907, and the response method specifying section 909, respectively.

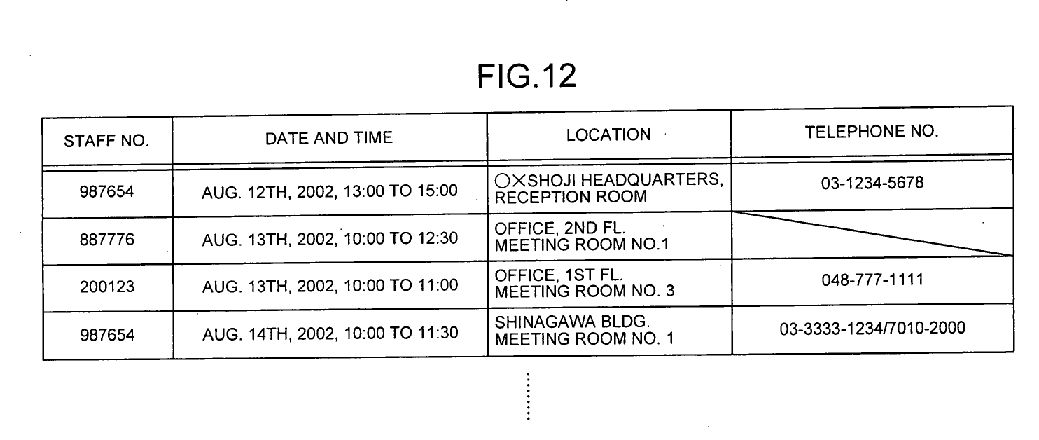

Returning to FIG. 9, the meeting schedule extracting section 905 is a functional section that refers to the schedule master 906 as shown in FIG. 12, by the employee number and the customer telephone number input from the staff information extracting section 903, to extract a record of the present or future meeting schedule between the staff in charge and the caller. The meeting schedule extracting section 905 then outputs the whole items of the extracted record and a flag indicating whether there is a future meeting schedule to the display section 911.

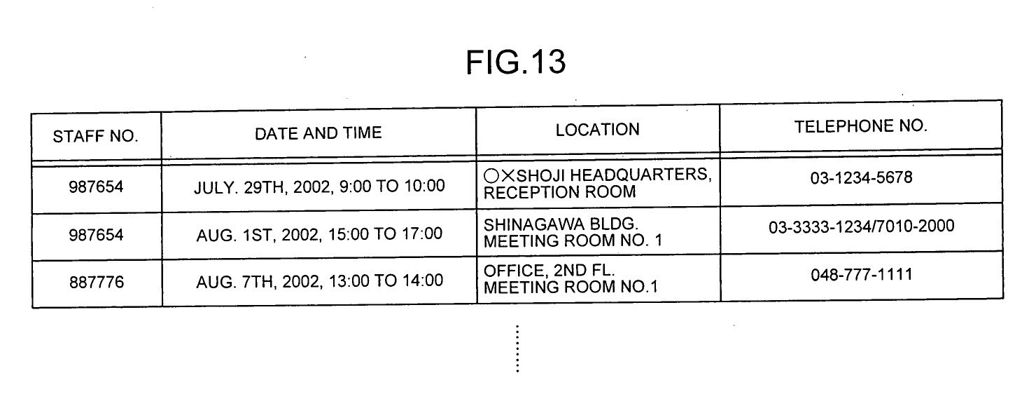

Returning to FIG. 9, the meeting history extracting section 907 is a functional section that refers to the meeting history master 908 as shown in FIG. 13, by the employee number and the customer telephone number input from the staff information extracting section 903, to extract a record of the past meeting history between the staff in charge and the caller. The meeting history extracting section 907 then outputs the whole items of the extracted record to the display section 911.

The meeting history master 908 is automatically generated from the schedule master 906. In other words, the schedule master 906 is regularly checked, and if there is a record in which the “date and time” field is previous than the present, and some telephone number is set in a field of “telephone number”, the record is shifted to the meeting history master 908.

Only the records with the telephone number set therein are shifted, because, in various schedules such as meeting, business trip, seminar, and holidays registered in the schedule master 906, a record in which the telephone number of the other party exists is assumed to be a schedule to meet someone. Even for an arrangement not only with the customers but also with other staff, by setting the telephone number of the staff, the meeting history can be hold in the meeting history master 908.

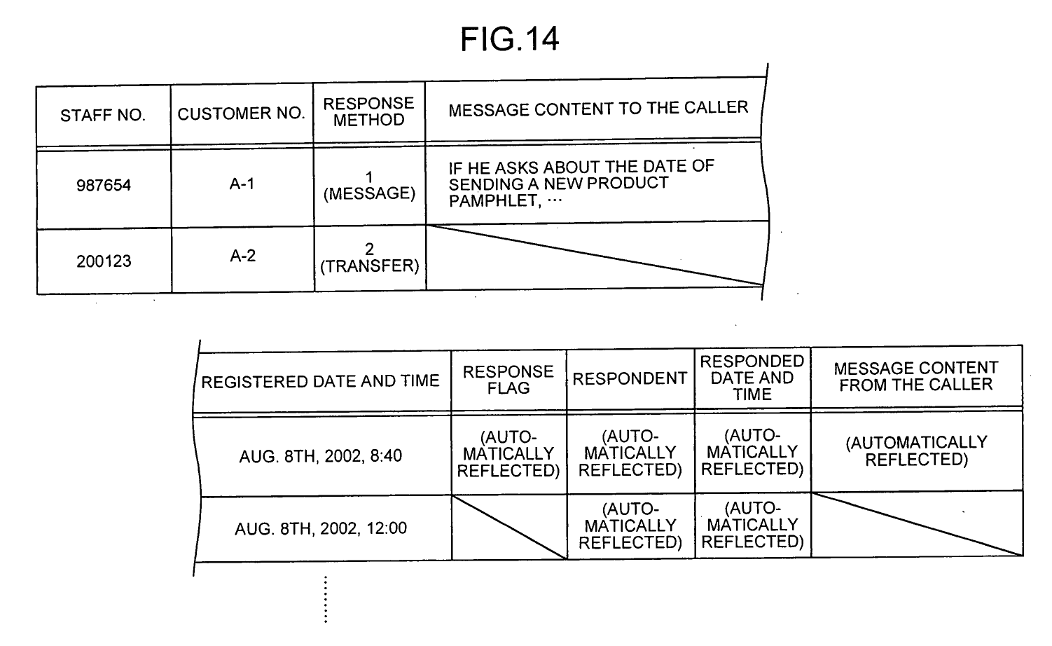

Returning to FIG. 9, the response method specifying section 909 is a functional section that refers to the response method master 910 as shown in FIG. 14, by the employee number and the customer number input from the staff information extracting section 903, to determine the response method specified in advance by the staff in charge with respect to the incoming telephone call from the caller. In the example shown in the figure, number 1 denotes the “message”, number 2 denotes “transfer”, number 3 (not shown) denotes “reject reception”, and when there is no corresponding record in the response method master 910, it indicates that “no specification” is specified.

When “message” is specified as the response method in the field of “message content to the caller”, of various items in the response method master 910, the message content to be delivered to the caller is held. A “response flag” denotes a flag indicating whether the message is delivered, the employee number of the respondent staff is written in the “respondent” field, date and time of the response is written in the “responded date and time” field, and the message content from the caller is written in the field of “message content from caller”, and all fields are automatically updated based on the screen in FIG. 3 after finishing the call (blank when no response is made).

If the response method master 910 has also a “validity” field, so that a record having passed this time limit is automatically deleted, unnecessary old message is prevented from being delivered again by staff who does not know the situation. However, there is an instance in which rejection of reception is desired indefinitely, for example, calls for sales purpose. Therefore, “no validity (indefinite)” may be set as the validity.

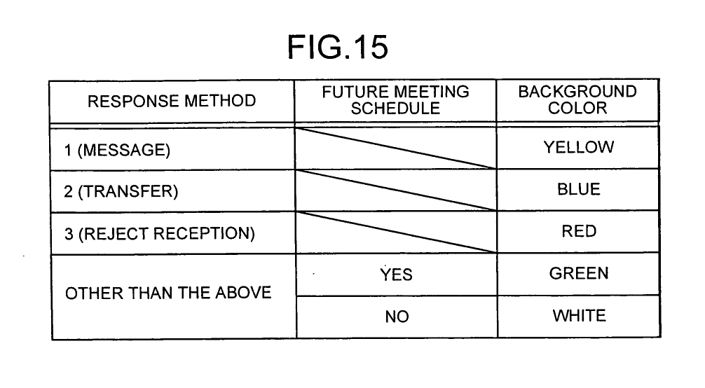

The display section 911 is a functional section that displays a screen as shown in FIG. 2, when it is informed of start of conversation by the telephone monitoring section 900, or screens as shown in FIGS. 3, 5, and 6, when it is informed of end of conversation, respectively, on the display 808. The display section 911 refers to the background color master 912 as shown in FIG. 15, when deciding the background color on the screen shown in FIG. 2.

The response result notifying section 913 is a functional section that transmits an electronic mail as shown in FIG. 4 or FIG. 7 to the staff in charge who should originally respond to the call, when the response method indicates “message”, or when the call is from a customer who has an appointment with the staff in charge in the near future, though the response method is not particularly specified.

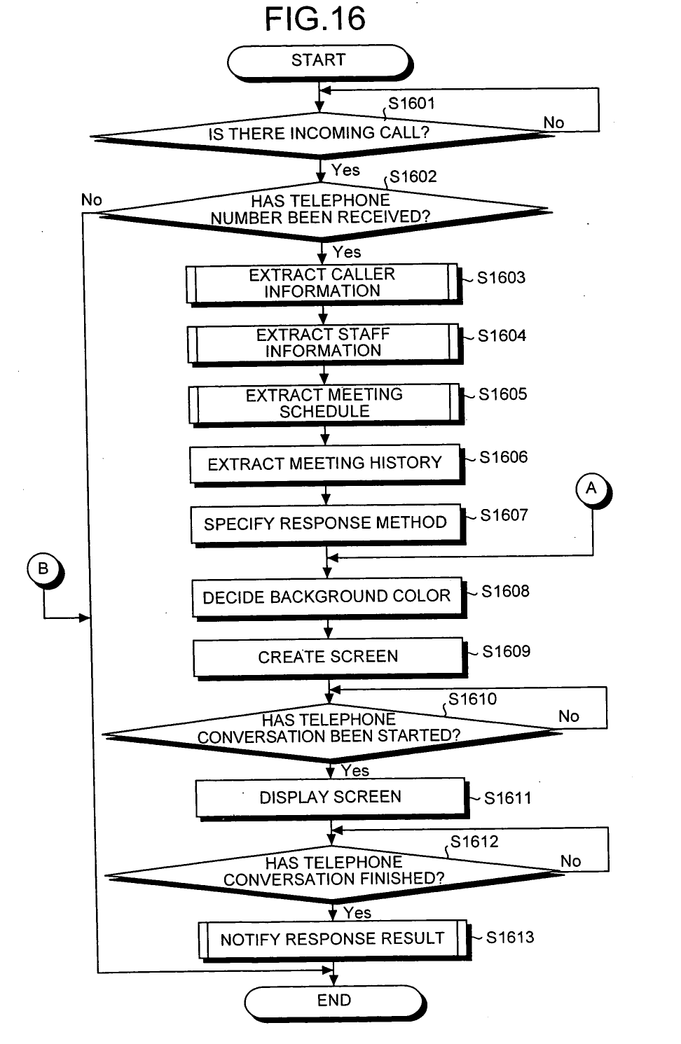

FIG. 16 is a flowchart indicating a procedure in the response method display processing, in the information processing apparatus according to the embodiment of the present invention.

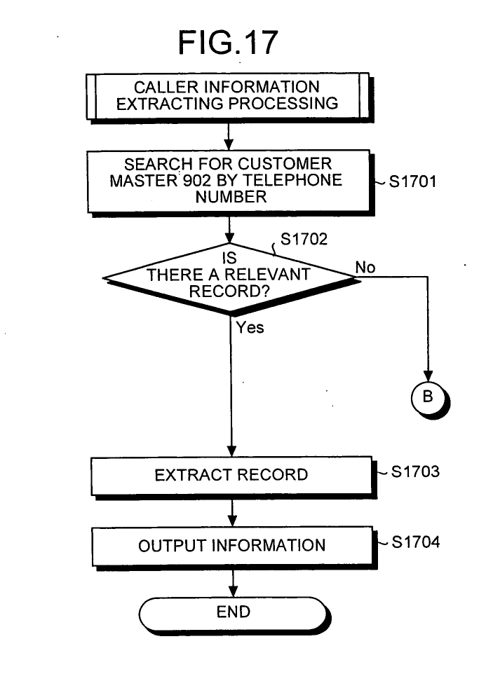

When the telephone monitoring section 900 detects an incoming telephone call (step S1601: Yes), and when the telephone number of the caller can be identified (step S1602: Yes), the apparatus extracts the caller information by the caller information extracting section 901 (step S1603). FIG. 17 is a flowchart indicating the procedure in the caller information extracting processing in detail.

The caller information extracting section 901 searches for a record having a telephone number matching the telephone number input from the telephone monitoring section 900 (step S1701), and if there is such a record (step S1702: Yes), extracts the record from the customer master 902 (step S1703). The caller information extracting section 901 then outputs the whole items in the extracted record to the display section 911, and the customer number and the telephone number to the staff information extracting section 903, respectively (step S1704).

When the telephone number cannot be identified because the incoming telephone call is not set “own number display mode” (step S1602: No, in FIG. 16), or when the telephone number has been identified, but the relevant record is not present in the customer master 902 (step S1702: No, in FIG. 17), the processing described below is skipped and finished. It is because the following processing cannot be continued unless the caller can be identified. However, the processing may be such that, for example, a message “the telephone number cannot be identified, or it is not registered. Please ask the caller's name and input below.” is displayed on the screen, instead of the screen in FIG. 2, to ask the respondent to obtain additional information for identifying the caller.

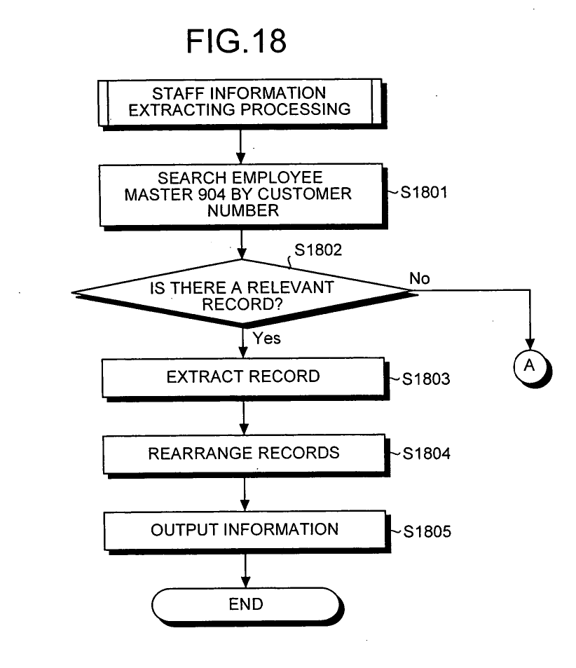

Returning to FIG. 16, when the caller information is extracted, the apparatus extracts the information of the staff in charge, who should originally respond to the caller, by the staff information extracting section 903 (step S1604). FIG. 18 is a flowchart indicating a procedure in the staff information extracting processing in detail.

The staff information extracting section 903 refers to the employee master 904 in FIG. 11 by the customer number input from the caller information extracting section 901 (step S1801), and if there is a relevant record (step S1802: Yes), extracts the record from the employee master 904 (step S1803).

The staff information extracting section 903 rearranges the extracted records so that the telephone number matching the telephone number of the telephone having answered the phone is located at a higher rank, and the other telephone numbers are located at lower ranks (step S1804), and outputs the whole items of these records to the display section 911. The staff information extracting section 903 also outputs the employee number, and the customer number and telephone number input from the caller information extracting section 901 to the meeting schedule extracting section 905, the meeting history extracting section 907, and the response method specifying section 909, respectively (step S1805).

If the relevant record is not present in the employee master 904 (step S1802: No), the meeting schedule extracting processing (step S1605), the meeting history extracting processing (step S1606), and the response method specifying processing (step S1607) are skipped, and only the information of the customer, being the caller, is displayed.

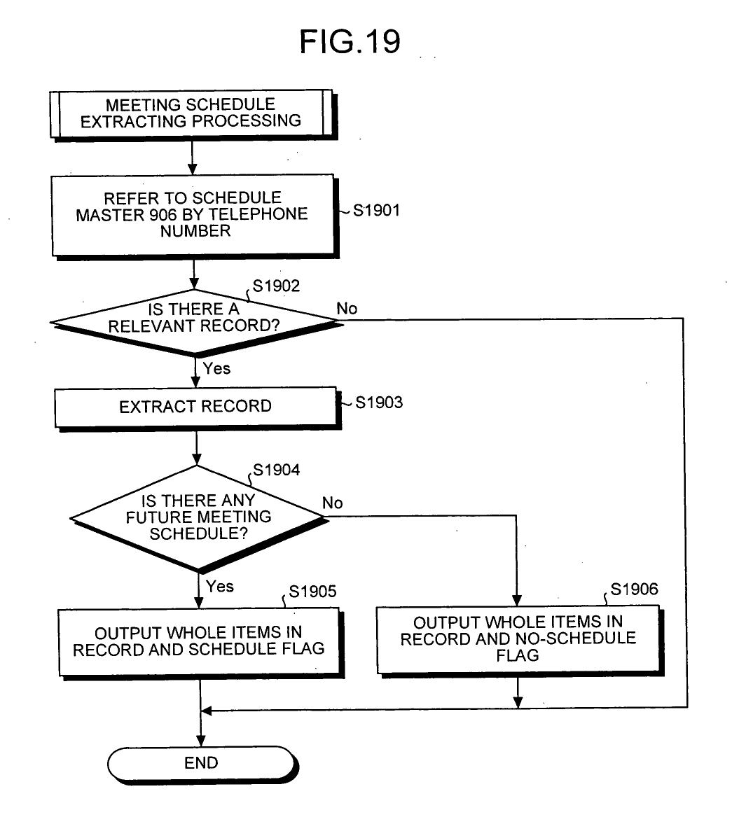

Returning to FIG. 16, when the caller information and the staff information are extracted, the apparatus extracts a meeting schedule of the staff in charge with the customer from the schedule master 906 shown in FIG. 12 by the meeting schedule extracting section 905 (step S1605). FIG. 19 is a flowchart indicating a procedure in the meeting schedule extracting processing in detail.

The meeting schedule extracting section 905 refers to the schedule master 906 shown in FIG. 12 by the employee number and the telephone number input from the staff information extracting section 903 (step S1901), and if there is a relevant record (step S1902: Yes), extracts the record from the schedule master 906 (step S1903).

When there is a record in which the starting date and time is for the future in the extracted records, that is, a future meeting schedule is included therein (step S1904: Yes), the meeting schedule extracting section 905 outputs the whole items of the extracted record and the information of the meeting schedule, and if a future meeting schedule is not included therein (step S1904: No), outputs the whole items of the extracted record and the information indicating there is no future meeting schedule, respectively, to the display section 911 (steps S1905 and S1906).

Returning to FIG. 16, when the meeting schedule information is extracted, the apparatus extracts the meeting history of the staff in charge with the caller by the meeting history extracting section 907 from the meeting history master 908 (step S1606).

After having extracted various information to be displayed on the screen in FIG. 2, the apparatus sets the response method specified by the staff in charge, who is identified at step S1604 (when there is a plurality of staff in charge, the staff whose telephone number matches the telephone number of the telephone, which is to receive the call), with respect to the call from the caller (step S1607). In other words, if the relevant record is present in the response method master 910 in FIG. 14, the response method specified by the record number is set, and if not, “no specification” is set.

The display section 911 then decides the background color on the screen to be displayed, based on the response method specified by the response method specifying section 909 and the presence of a future schedule notified by the meeting schedule extracting section 905 (step S1608). That is, as shown in the background color master 912 in FIG. 15, yellow, blue, or red is determined, respectively, when the response method is “message”, “transfer”, or “reject reception”. In the case of “no specification”, or when the caller does not have staff in charge, the background color is white as a rule, but the background color is set to green, only when the customer has a future meeting schedule.

The display section 911 fills the various information extracted at steps S1603 to S1606 in a window of the decided background color, to create a screen as shown in FIG. 2 (step S1609), and displays the screen (step S1611), when the telephone monitoring section 900 notifies the start of telephone conversation (step S1610: Yes).

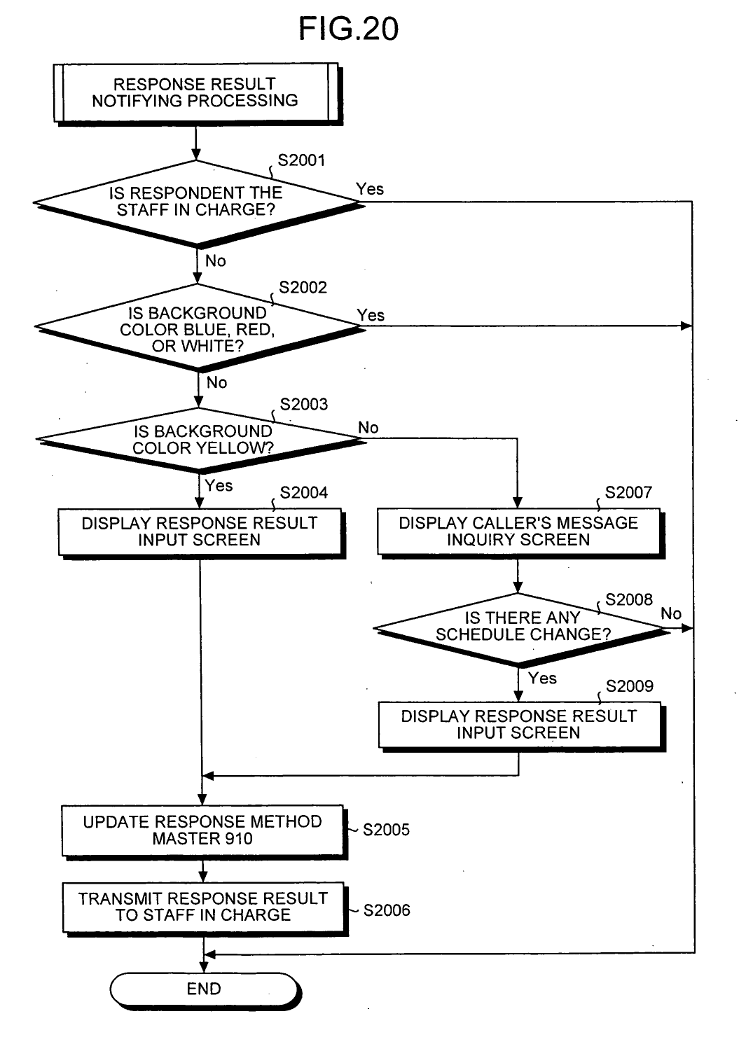

The screen is displayed continuously until the telephone conversation finishes, and when the receiver is hung up (step S1612: Yes), the response result notifying section 913 notifies the staff in charge, who should originally respond to the call, of the response result (step S1613). FIG. 20 is a flowchart indicating a procedure in the response result notifying processing in detail.

When the actual respondent is the staff in charge (step S2001: Yes), or even if the respondent is an other staff, when the background color on the screen displayed by the display section 911 at step S1611 is blue, red, or white, (step S2001: No, step S2002: Yes), the response result notifying section 913 finishes the processing in this flowchart. Who is the respondent (whether the staff in charge has responded) can be identified by referring to the employee master 904 by the extension number, which is actually used for the telephone conversation.

On the other hand, when the respondent is the other staff, and the background color is yellow, that is, when “message” is specified as the response method (step S2001: No, step S2002: No, step S2003: Yes), the response result notifying section 913 instructs the display section 911 to display an input screen as shown in FIG. 3 (step S2004). The name of the staff, who has answered the call (identified from the extension number), is input in the “respondent” column on the screen, and the current date and time are input in a “responded date and time” column, respectively by default.

The response result notifying section 913 updates the response method master 910 based on the input of response result or the input of a message from the caller on the screen, and correction of the respondent and the responded date and time (step S2005), creates an electronic mail as shown in FIG. 4, and transmits the electronic mail to the staff in charge who is out of office (step S2006).

On the other hand, when the background color is green, that is, though the response method is not specified, there is a future meeting schedule with the caller (step S2003: No), the response result notifying section 913 instructs the display section 911 to display an enquiry screen as shown in FIG. 5 (step S2007).

When “Yes” is selected on the screen, that is, when the message of the caller is for changing the appointment (step S2008: Yes), the response result notifying section 913 instructs the display section 911 to display an input screen as shown in FIG. 6. The response result notifying section 913 then updates the response method master 910, based on the input of desired date and time or desired location on the screen, and correction of the respondent and the responded date and time (step S2005), creates an electronic mail as shown in FIG. 7, and transmits the electronic mail to the staff in charge who is out of office (step S2006).

According to the embodiment described above, even when the staff in charge is out of the office, and any other staff responds to the incoming telephone call, uniform response is possible according to the intention of the staff in charge. Since a plurality of staff in charge is displayed on the screen in FIG. 2, even when the staff in charge, who should originally respond to the call, is out of office, the incoming telephone call can be transferred to the other staff in charge.

Since the personal information of the caller, whether the caller keeps company with the staff in charge frequently, and whether there is a meeting schedule with him in the near future, are displayed, prediction or understanding of the business of the caller is possible in a minute. Therefore, it is not necessary for the caller to repeat explanation of the matter (telephone number, or the content of meeting schedule). Even when the staff in charge responds to the incoming telephone call, the information is useful for easy understanding of the business.

Further, a message can be delivered reliably to the caller, and an incoming telephone call, which the staff in charge wants to answer, can be reliably transferred to him/her even during a meeting. On the contrary, in the case of a call from a salesman or a canvasser whom the staff in charge does not want to speak, it is difficult to reject the incoming telephone call in a company, but if an other staff can tell that he/she is out of office, the call can be rejected without giving unpleasant impression to the caller.

How the respondent has responded to the call is notified to the staff in charge after finishing the telephone conversation, as required. Therefore, omission or error in the report and delay of the report can be prevented, and the staff in charge can be notified of the result quickly and reliably. Further, since it is a notification by an electronic mail, the staff in charge can confirm the content anytime, anywhere.

The CPU 801 executes a program read from the HD 805 into the RAM 803, to thereby realize the telephone monitoring section 900, the caller information extracting section 901, the staff information extracting section 903, the meeting schedule extracting section 905, the meeting history extracting section 907, the response method specifying section 909, the display section 911, and the response result notifying section 913. The program may be stored and distributed in various recording media such as the FD 807, CD-ROM (CR-R, CD-RW), and MO, other than the HD 805, and may be distributed via a network.

The customer master 902, the employee master 904, the schedule master 906, the meeting history master 908, the response method master 910, and the background color master 912 are realized by the HD 805.

Thus, according to the present invention, information relating to who is the caller and how to respond to the call is displayed on the PC of the respondent who has actually answered the phone, and the response by the respondent is notified to the staff in charge by an electronic mail. As a result, the information processing method, the information processing program, and the information processing apparatus can be obtained, which can provide appropriate and uniform service (having no difference individually) corresponding to the other party, no matter who answers the phone, other than the staff in charge, and can notify the staff in charge of the response result quickly and reliably.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method for processing information comprising:
extracting information relating to a telephone caller;
deciding a background color of a window based on a response method specified by a staff in charge, as a target for responding to the caller, corresponding to the caller; and
displaying the information relating to the caller in a window with the background color decided.

2. The method according to claim 1, further comprising:
extracting information relating to the staff in charge, wherein
the displaying includes displaying the information relating to the staff in charge in the window.

3. The method according to claim 1, further comprising:
extracting information relating to a meeting between the caller and the staff in charge, wherein
the displaying includes displaying the information relating to the meeting in charge in the window.

4. The method according to claim 1, wherein if the response method is to deliver of a message from the staff in charge to the caller, the displaying includes displaying contents of the message in the window.

5. The method according to claim 1, further comprising, if the response method is to deliver of a message from the staff in charge to the caller, notifying, to the staff in charge by an electronic mail, whether the message is delivered to the caller.

6. The method according to claim 1, further comprising, if the response method has not been specified and there is a future meeting plan between the staff in charge and the caller, notifying the staff in charge of a change in date or location of the meeting by an electronic mail.

7. A computer program making a computer execute:
extracting information relating to a telephone caller;
deciding a background color of a window based on a response method specified by a staff in charge, as a target for responding to the caller, corresponding to the caller; and
displaying the information relating to the caller in a window with the background color decided.

8. An apparatus for processing information comprising:
a caller information extracting unit that extracts information relating to a telephone caller;
a background color deciding unit that decides a background color of a window based on a response method specified by a staff in charge, as a target for responding to the caller, corresponding to the caller; and
a display unit that displays the information relating to the caller in a window with the background color decided.
